(19) United States
(12) Patent Application Publication
(10) Pub. No.: US 2015/0072202 A1
(43) Pub. Date: Mar. 12, 2015

(54) ELECTROCHEMICAL DEVICE

(71) Applicant: Dongguan Amperex Technology Limited, Dongguan (CN)

(72) Inventors: Cong LI, Dongguan (CN); Yunlong Wang, Dongguan (CN); Ping He, Dongguan (CN); Zhong Shi, Dongguan (CN); Hongxin Fang, Dongguan (CN); Baiqing Zhang, Dongguan (CN)

(21) Appl. No.: 14/292,517

(22) Filed: May 30, 2014

(30) Foreign Application Priority Data
Sep. 12, 2013 (CN) 201310415742.6

(51) Int. Cl. H01G 11/12; H01M 6/46; H01M 10/04; H01M 6/42

(52) U.S. Cl. CPC H01G 11/12; H01M 6/42; H01M 6/46; H01M 10/04; H01M 10/0436; H01M 10/0431; H01M 2220/30
USPC 429/94; 429/152; 361/502

(57) ABSTRACT

The present disclosure provides an electrochemical device, which comprises a plurality of cells which are stacked in a step configuration, electrode tabs of the same polarity of the plurality of cells are electrically connected together. Compared with only using a single wound-type cell or only using a single laminated-type cell, the plurality of cells stacked in the step configuration of the present disclosure can more flexibly adapt to an irregular inner space of an electronic device using the electrochemical device, so that the inner space in the electronic device is fully used, the performance of the electrochemical device for use in the electronic device is improved, and the manufacturing process is more simple, flexible and efficient.

### CROSS-REFERENCE TO RELATED APPLICATIONS

The present application claims priority to Chinese patent application No. 201310415742.6 filed on Sep. 12, 2013, which is incorporated herein by reference in its entirety.

### TECHNICAL FIELD OF THE PRESENT DISCLOSURE

The present disclosure relates to the field of energy storage devices, particularly relates to an electrochemical device.

### BACKGROUND OF THE PRESENT DISCLOSURE

Lithium-ion batteries are mainly used in mobile devices, such as mobile phones, laptops and digital cameras, its compact characteristics are increasingly prominent, which requires high energy density of the lithium-ion battery.

However, at present, improving the energy density of the lithium-ion battery depending on improvement on materials is more and more difficult, and improving the energy density by more efficient use of space appears particularly important. At present, spaces left in the mobile devices for displacement the battery are almost not regular rectangular, an arrangement of other electronic components often appears an irregularly one as a step profile, when a regular single square lithium-ion battery is used, an inner space of the device will be idle and wasted to a certain extent.

### SUMMARY OF THE PRESENT DISCLOSURE

In view of the problem existing in the background, an object of the present disclosure is to provide an electrochemical device, which can flexibly adapt to an irregular inner space of an electronic device using the electrochemical device, so as to fully use the inner space in the electronic device, and improve performance of the electrochemical device for use in the electronic device.

Another object of the present disclosure is to provide an electrochemical device, which can allow the manufacturing process more simple, flexible and efficient.

In order to achieve the above objects, the present disclosure provides an electrochemical device comprising a plurality of cells which are stacked in a step configuration, electrode tabs of the same polarity of the plurality of cells are electrically connected together.

Compared with only using a single wound-type cell or only using a single laminated-type cell, the plurality of cells stacked in the step configuration of the present disclosure can more flexibly adapt to an irregular inner space of an electronic device using the electrochemical device, so that the inner space in the electronic device is fully used, the performance of the electrochemical device for use in the electronic device is improved, and the manufacturing process is more simple, flexible and efficient.

### BRIEF DESCRIPTION OF THE FIGURES

FIG. 1 is a structural schematic diagram of a plurality of cells according to an embodiment of an electrochemical device of the present disclosure;

FIG. 2 is a structural schematic diagram of a plurality of cells according to an embodiment of an electrochemical device of the present disclosure;

FIG. 3 is a structural schematic diagram of the plurality of cells according to an embodiment of an electrochemical device of the present disclosure;

FIG. 4 is a structural schematic diagram of a plurality of cells according to an embodiment of an electrochemical device of the present disclosure;

FIG. 5 is a structural schematic diagram of a plurality of cells according to an embodiment of an electrochemical device of the present disclosure;

FIG. 6 is a structural schematic diagram of a plurality of cells according to an embodiment of an electrochemical device of the present disclosure;

FIG. 7 is a structural schematic diagram of a plurality of cells according to an embodiment of an electrochemical device of the present disclosure;

FIG. 8 is a structural schematic diagram of a plurality of cells according to an embodiment of an electrochemical device of the present disclosure;

FIG. 9 is a structural schematic diagram of a plurality of cells according to an embodiment of an electrochemical device of the present disclosure;

FIG. 10 is a structural schematic diagram of a plurality of cells according to an embodiment of an electrochemical device of the present disclosure;

FIG. 11 is a structural schematic diagram of a plurality of cells according to an embodiment of an electrochemical device of the present disclosure;

FIG. 12 is a structural schematic diagram of a plurality of cells according to an embodiment of an electrochemical device of the present disclosure, illustrating partial contour of two cells positioned below for the sake of clarity;

FIG. 13 is a structural schematic diagram of a plurality of cells according to an embodiment of an electrochemical device of the present disclosure;

FIG. 14 is a structural schematic diagram of a plurality of cells according to an embodiment of an electrochemical device of the present disclosure;

FIG. 15 is a structural schematic diagram of a plurality of cells according to an embodiment of an electrochemical device of the present disclosure;

FIG. 16 is a structural schematic diagram of a plurality of cells according to an embodiment of an electrochemical device of the present disclosure;

FIG. 17 is a structural schematic diagram of a plurality of cells according to an embodiment of an electrochemical device of the present disclosure;

FIG. 18 is a structural schematic diagram of a plurality of cells according to an embodiment of an electrochemical device of the present disclosure;

FIG. 19 is a structural schematic diagram of a plurality of cells according to an embodiment of an electrochemical device of the present disclosure;

FIG. 20 is an enlarged view of the circled portion of FIG. 19;

FIG. 21 is a structural schematic diagram of a plurality of cells according to an embodiment of an electrochemical device of the present disclosure, illustrating an insulative adhesive strip at a left side with grid for the sake of clarity; and

FIG. 22 is an enlarged view of a circled portion of FIG. 21.

Reference numerals of the embodiments are represented as follows:
1 cell
2 electrode tab
3 insulative adhesive strip
W width direction
L length direction

### DETAILED DESCRIPTION

Hereinafter an electrochemical device according to the present disclosure will be described in details in combination with the Figures. In the following description, a length and a width of a cell 1 can be defined by reference to an indication L for a length direction and an indication W for a width direction in the Figures.

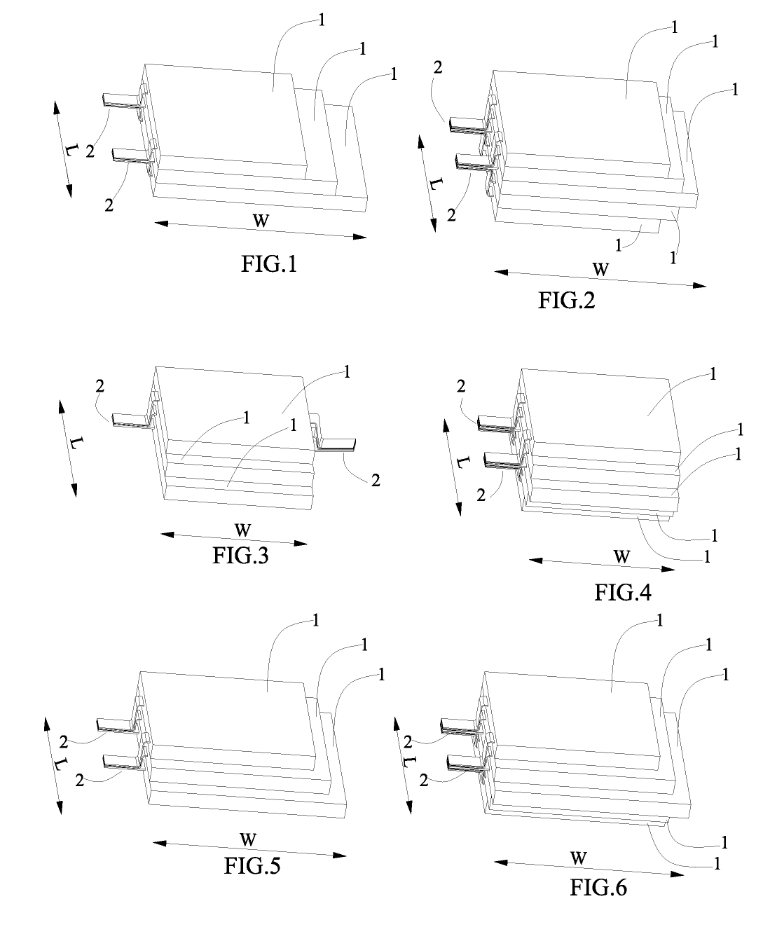

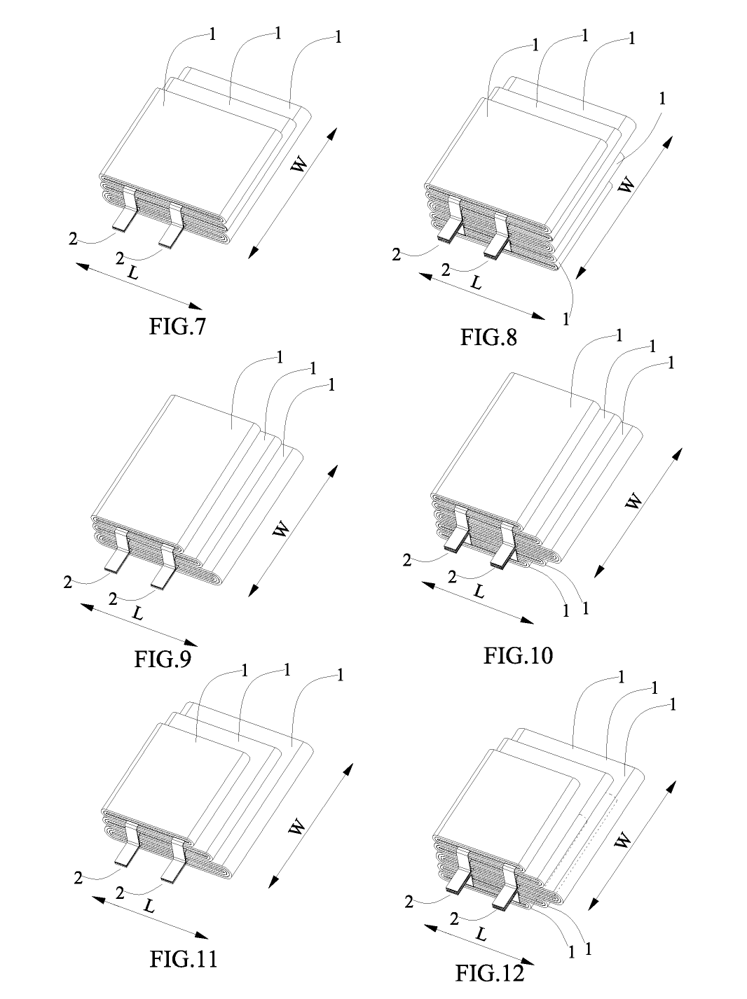

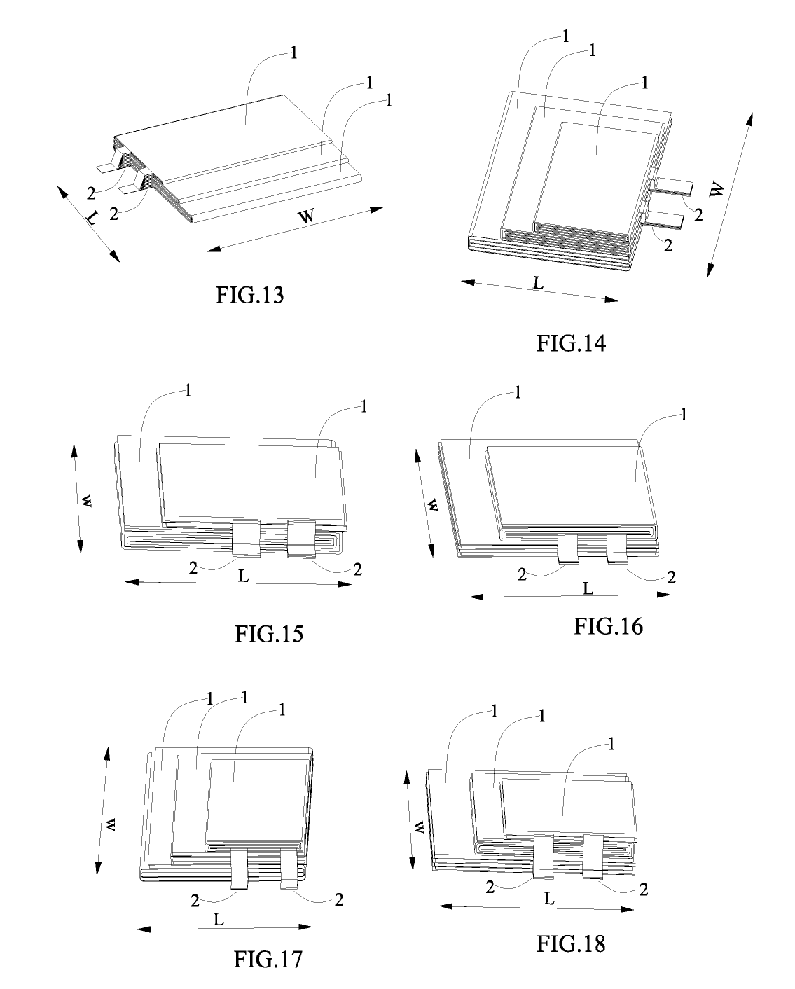

Referring to FIGS. 1-22, an electrochemical device according to the present disclosure comprises a plurality of cells 1 which are stacked in a step configuration, electrode tabs 2 of the same polarity of the plurality of cells 1 are electrically connected together. The plurality of cells of the present disclosure which is stacked in a step configuration and connected in parallel can more flexibly adapt to an irregular inner space of an electronic device using the electrochemical device, so that the inner space in the electronic device is fully used, performance of the electrochemical device for use in the electronic device (for example, the energy density when the electrochemical device is a battery) is improved, and manufacturing process is more simple, flexible and high efficient.

In an embodiment of the electrochemical device according to the present disclosure, referring to FIGS. 1-6, the plurality of cells 1 are all laminated-type cells.

In an embodiment of the electrochemical device according to the present disclosure, referring to FIGS. 7-14, FIG. 19 and FIG. 21, the plurality of cells 1 are all wound-type cells. That only the wound-type cell is used can allow the manufacturing process of the electrochemical device simple, and industrial manufacture efficient high. In an embodiment of the electrochemical device according to the present disclosure, referring to FIGS. 15-18, a part of the plurality of cells 1 are laminated-type cells and the other part are wound-type cells. Specifically, in the FIG. 15, the cells 1 positioned at a low part are wound-type cells, the cells 1 positioned at an upper part are laminated-type cells; in the FIG. 16, the cells 1 positioned at a low part are laminated-type cells, and the cells 1 positioned at an upper part are wound-type cells; in the FIG. 17, the cells 1 at top and bottom are wound-type cells, and the cells 1 in the middle are laminated-type cells; in the FIG. 18, the cells 1 at top and bottom are laminated-type cells, and the cells 1 in the middle are wound-type cells.

Compared with the electrochemical device only using wound-type cell or only using laminated-type cell, using combination of the laminated-type cell and the wound-type cell can not only allow the electrochemical device to more flexibly adapt to the irregular inner space of the electronic device and also has the following effects: (1) the wound-type cell has mature manufacturing technology, and low cost, and the laminated-type cell has tedious manufacturing, and high cost, therefore, when the inner space left in the electronic device for the cell is irregular, for the deeper part in the inner space, a corresponding part of the cells of the electrochemical device can use the wound-type cell, so as to reduce processes and reduce cost; (2) as an electrode plate can be cut into any small size for the laminated-type cell, the laminated-type cell having a smaller area can be obtained, however it is difficult for the wound-type cell, therefore, when the inner space left in the electronic device for the cell is irregular, for the shallower or smaller part in the inner space, a corresponding part of the cells of the electrochemical device can use the laminated-type cell, so as to make use of and adapt to the inner space for the shallower or smaller part better, so as to meet various requirements for small space and high energy density; (3) the laminated-type cell has good wettability in an electrolyte, and positions of a positive electrode plate and a negative electrode plate can be adjusted at random, therefore, for the shallower or smaller part in the inner space, a corresponding part of the cells of the electrochemical device can use the laminated-type cell, so as to greatly improve the wettability of the whole cell in the electrolyte and in turn improve electrochemical performances such as charge and discharge capacity; (4) the laminated-type cell has low risk of deformation caused by expansion in charge-discharge process, therefore, for the shallower or smaller part in the inner space, a corresponding part of the cells of the electrochemical device may use the laminated-type cell, so as to ensure the arrangement of the whole cell in the irregular inner space (namely the configuration stability).

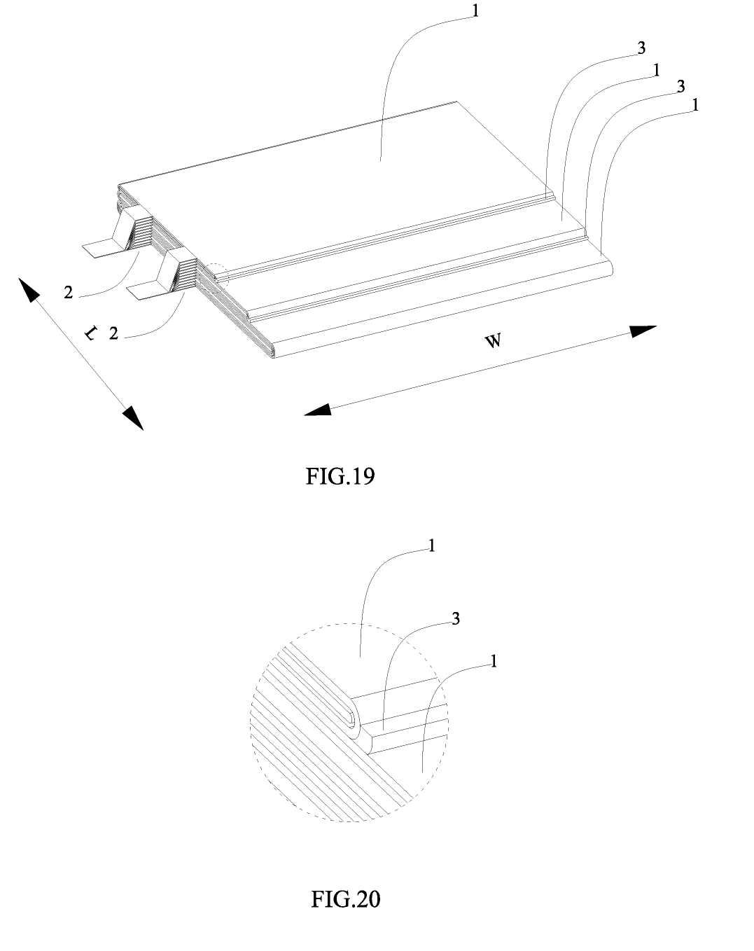

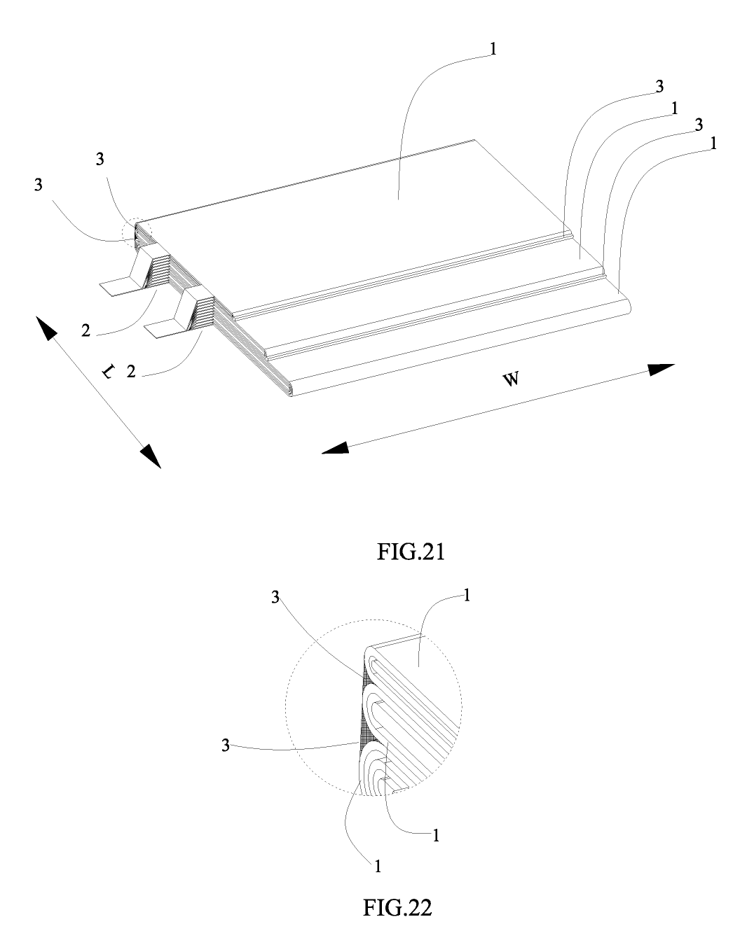

In an embodiment of the electrochemical device according to the present disclosure, referring to FIG. 3, FIG. 4, FIG. 9, FIG. 10, FIG. 13, FIG. 19 and FIG. 21, the plurality of cells 1 have different lengths and the stacking in the step configuration forms a length-direction step. In an embodiment, referring to FIG. 4 and FIG. 10, the length-direction step is a length-direction step gradually reducing respectively toward an upper side and a lower side from a middle one of the plurality of cells 1 along a length direction L, the middle one has the greatest length among the plurality of cells 1.

In an embodiment of the electrochemical device according to the present disclosure, referring to FIG. 1, FIG. 2, FIG. 7, and FIG. 8, the plurality of cells 1 have different widths and the stacking in the step configuration forms a width-direction step. In an embodiment, referring to FIG. 2 and FIG. 8, the width-direction step is a width-direction step gradually reducing respectively toward an upper side and a lower side from a middle one of the plurality of cells 1 along a width direction W, the middle one has the greatest length among the plurality of cells 1.

In an embodiment of the electrochemical device according to the present disclosure, referring to FIG. 5, FIG. 6, FIG. 11, FIG. 12, FIGS. 14-18, the plurality of cells 1 have different lengths and widths and the stacking in the step configuration forms a tower-shaped step. In an embodiment, referring to FIG. 6 and FIG. 12, the tower-shaped step is a tower-shaped step gradually reducing respectively toward an upper side and a lower side from a middle one of the plurality of cells 1 along a length direction L and a width direction W, the middle one has the greatest length and the greatest width among the plurality of cells 1.

In an embodiment of the electrochemical device according to the present disclosure, referring to FIGS. 1-19 and FIG. 21, edges of the plurality of cells 1 at the electrode tabs 2 are flush with each other.

In an embodiment of the electrochemical device according to the present disclosure, referring to FIGS. 1-19 and FIG. 21, the electrode tabs 2 of the same polarity of the plurality of cells 1 are aligned with each other.

In an embodiment of the electrochemical device according to the present disclosure, referring to FIGS. 1-19 and FIG. 21, a step formed by the stacking in the step configuration is provided as at least two in number, a height of the each step is 0.1-20.0 mm, preferably, the height of the each step may be 0.2-10.0 mm, which can greatly effectively make use of the existing space to make the maximum capacity of the cell function.

In an embodiment of the electrochemical device according to the present disclosure, referring to FIGS. 1-19 and FIG. 21, the electrode tab 2 of the same polarity of the each cell 1 is provided as at least one in number. In the FIGS. 1-12 and FIGS. 15-18, the electrode tab 2 of the same polarity of the each cell 1 is provided as one in number; in the FIG. 13, FIG. 19 and FIG. 21, the electrode tab 2 of the same polarity of the each cell 1 is provided as more than one in number.

In an embodiment of the electrochemical device according to the present disclosure, the electrode tabs 2 of different polarities of the plurality of cells 1 may be positioned at the same side (referring to FIG. 1, FIG. 2, FIGS. 4-19 and FIG. 21). For the electrochemical device with the electrode tabs 2 of different polarities of the plurality of cells 1 positioned at the same side, polarization of the battery is low when the cell is in the charge-discharge process, the rate performance of the cell is better, so that higher capacity functions. In another embodiment, the electrode tabs 2 of different polarities of the plurality of cells 1 may be positioned at different sides (referring to FIG. 3).

In an embodiment of the electrochemical device according to the present disclosure, referring to FIGS. 1-13, FIGS. 15-19 and FIG. 21, the each electrode tab 2 of the each cell 1 may be formed by cutting a corresponding current collector along a width direction W. The electrochemical device using the electrode tab formed in this way, an internal resistance of the cell is low, heat generated in the charge-discharge process is low, idle work is low, so that the energy density is improved, in addition, it can effectively reduce short-circuit risk of puncturing a separator in manufacture and use of the cell if an electrode tab connected from outside is used. Alternatively, referring to FIGS. 1-13, FIGS. 15-19 and FIG. 21, the each electrode tab 2 of the each cell 1 may be welded to a corresponding current collector (not shown) along a width direction W.

In an embodiment of the electrochemical device according to the present disclosure, referring to FIG. 14, when the cell 1 is the wound-type cell, the each electrode tab 2 of the cell 1 may be formed by cutting a corresponding terminal end of a current collector (not shown) when the cell 1 is wound along a length direction L. The electrochemical device using the electrode tab formed in this way, internal resistance of the cell is low, heat generated in a charge-discharge process is low, idle work is low, so that energy density is improved, in addition, it can effectively reduce short-circuit risk of puncturing a separator in manufacture and use of the cell if an electrode tab connected from outside is used. Alternatively, referring to FIG. 14, when the cell 1 is the wound-type cell, the electrode each tab 2 of the cell 1 can be welded to a corresponding terminal end of a current collector (not shown) when the cell 1 is wound along a length direction L.

In an embodiment of the electrochemical device according to the present disclosure, contact surfaces of two adjacent cells 1 are adhered together via an insulative adhesive (not shown in the Figures). In another embodiment, referring to FIGS. 19-22, an insulative adhesive strip 3 extending outwardly along the length direction L is provided at edges of the contact surfaces of the two adjacent cells 1 along the width direction W to seal the edges of the contact surface of the two adjacent cells 1 along the width direction W. In the FIGS. 19-20, the insulative adhesive strip 3 at the right side not only fills a recessed portion (or a gap) formed between two adjacent cells 1 but also extends outwardly for a certain distance (and is formed for a certain height); and in the FIG. 21 and FIG. 22, the insulative adhesive strip 3 at the left side only fills a recessed portion (or a gap) formed between two adjacent cells 1. In addition, the insulative adhesive strip 3 can use thermally-conductive insulative adhesive. The insulative adhesive strip 3 can strengthen fixation of the two adjacent cells 1, the insulative adhesive strip 3 can function as limiting and buffering to eliminate deformation between the two adjacent cells 1 (for example expansion of the cell 1 caused by electrochemical action in the cell in practical use), so as to ensure to adapt to the irregular inner space of the electronic device; the insulative adhesive strip 3 can be served as extension of the step formed by the two adjacent cells 1, so as to more flexibly make full use of and adapt to the irregular inner space of the electronic device. In an embodiment of the electrochemical device according to the present disclosure, the each cell of the plurality of cells 1 may be but not limited to rectangular or rounded rectangle, semicircle and the like.

The electrochemical device according to the present disclosure may be a battery or a capacitor. The battery may be but not limited to a lithium-ion battery, the capacitor may be but not limited to a lithium-ion super-capacitor.

What is claimed is:

1. An electrochemical device, comprising a plurality of cells (1) which are stacked in a step configuration, electrode tabs (2) of the same polarity of the plurality of cells (1) being electrically connected together.

2. The electrochemical device according to claim 1, wherein the plurality of cells (1) are all laminated-type cells.

3. The electrochemical device according to claim 1, wherein the plurality of cells (1) are all wound-type cells.

4. The electrochemical device according to claim 1, wherein a part of the plurality of cells (1) are laminated-type cells and the other part are wound-type cells.

5. The electrochemical device according to claim 1, wherein the plurality of cells (1) have different lengths and the stacking in the step configuration forms a length-direction step.

6. The electrochemical device according to claim 5, wherein the length-direction step is a length-direction step gradually reducing respectively toward an upper side and a lower side from a middle one of the plurality of cells (1) along a length direction (L), the middle one has the greatest length among the plurality of cells (1).

7. The electrochemical device according to claim 1, wherein the plurality of cells (1) have different widths and the stacking in the step configuration forms a width-direction step.

8. The electrochemical device according to claim 7, wherein the width-direction step is a width-direction step gradually reducing respectively toward an upper side and a lower side from a middle one of the plurality of cells (1) along a width direction (W), the middle one has the greatest length among the plurality of cells (1).

9. The electrochemical device according to claim 1, wherein the plurality of cells (1) have different lengths and widths and the stacking in the step configuration forms a tower-shaped step.

10. The electrochemical device according to claim 9, wherein the tower-shaped step is a tower-shaped step gradually reducing respectively toward an upper side and a lower side from a middle one of the plurality of cells (1) along a length direction (L) and a width direction (W), the middle one has the greatest length and the greatest width among the plurality of cells (1).

11. The electrochemical device according to claim 1, wherein the electrode tabs (2) of the same polarity of the plurality of cells (1) are aligned with each other.

12. The electrochemical device according to claim 1, wherein the electrode tabs (2) of different polarities of the plurality of cells (1) are positioned at the same side.

13. The electrochemical device according to claim 1, wherein the each electrode tab (2) of the each cell (1) is formed by cutting a corresponding current collector along a width direction (W).

14. The electrochemical device according to claim 3, wherein the each electrode tab (2) of the each cell (1) is formed by cutting a corresponding terminal end of the current collector when the cell (1) is wound along the length direction (L).

15. The electrochemical device according to claim 4, wherein the each electrode tab (2) of the each cell (1) is formed by cutting a corresponding terminal end of the current collector when the cell (1) is wound along the length direction (L).

16. The electrochemical device according to claim 1, wherein a step formed by the stacking in the step configuration is provided as at least two in number, a height of the each step is 0.1-20.0 mm.

17. The electrochemical device according to claim 16, wherein the height of the each step is 0.2-10.0 mm.

18. The electrochemical device according to claim 1, wherein contact surfaces of two adjacent cells (1) are adhered together via an insulative adhesive.

19. The electrochemical device according to claim 1, wherein an insulative adhesive strip (3) extending outwardly along a length direction (L) is provided at edges of the contact surfaces of the two adjacent cells (1) along a width direction (W) to seal the edges of the contact surface of the two adjacent cells (1) along the width direction (W).

20. The electrochemical device according to claim 1, wherein the electrochemical device is a battery or a capacitor.
